(19) United States
(12) Patent Application Publication
(10) Pub. No.: US 2011/0125581 A1
(43) Pub. Date: May 26, 2011

(54) SYSTEM AND METHOD FOR IMPROVING E-COMMERCE WITH ON-DEMAND ADVERTISING

(76) Inventor: Reza Jalili, Sandy, UT (US)

(21) Appl. No.: 12/952,111

(22) Filed: Nov. 22, 2010

Related U.S. Application Data
(60) Provisional application No. 61/263,404, filed on Nov. 23, 2009.

(51) Int. Cl. G06Q 30/00

(52) U.S. Cl. 705/14.54

(57) ABSTRACT

A system and method for the searching of electronic ads. The present invention pertains to a registry accessible to disparate ad entities to allow for the registration of their electronic ads. Additionally, the present invention pertains to a search module that an ad entity may employ to enable the searching of electronic ads maintained at an associated server. Furthermore, the present invention pertains to a mechanism for gathering advertising content data published via a network to enable the searching of published electronic ads.

### TECHNICAL FIELD

The present invention generally pertains to processing electronic advertising content and/or other media on an electronic network in order to improve electronic commerce.

### BACKGROUND

The world of Internet commerce may be divided generally into these categories: Web site information detailing a company's products and services, e-commerce sites offering products and services for purchase, dedicated business-to-business and business-to-consumer sites where products and services are matched between buyers and sellers, and Internet advertising. Internet advertising involves placing an electronic advertisement, herein referred to as an “electronic ad,” on a Web page in the hope that a consumer will see it when viewing the Web page.

An electronic ad includes electronic advertising content and this content is distinct from other forms of electronic content distributed via the Internet. Electronic advertising content is created by a commercial entity in order to drive usage of a particular product or service. It is not merely content associated with a product or service, but rather is distributed specifically to generate a benefit (typically a monetary one) for the producer or supplier of the product or service. For example, an independent review of a product is not electronic advertising content, whereas advertising text distributed by the product manufacturer is electronic advertising content. An advertiser seeks wide-spread viewing of its ads and seeks direct gain from the viewing of its ads and from actions a viewer performs accordingly. Additionally, electronic advertising content is subject to advertising laws and regulations, such as truth-in-advertising laws.

An electronic ad may be created so that its distribution may be tracked and evaluated. For example, an electronic ad may include computer code that enables an advertiser to ascertain how many times it has been viewed (e.g., how many “impressions” or “clicks”). Electronic ad tracking may be conducted for financial purposes. For example, an ad provider may charge for ad distribution on a per viewing basis. An advertiser may be responsible for paying the ad provider each time the ad is viewed or fee for a particular amount of viewings.

Generally, electronic advertising works in the following way: a Web site publisher designates space on its Web site as available for advertising. An ad provider provides the publisher with a computer code to be implanted in this ad space. An ad provider is an entity that distributes electronic ads via a network (e.g., the Internet) on behalf of an advertiser, usually for a fee, such as Google AdSense, Yahoo, and the like. An advertiser is an entity wishing to promote a product, service, or the like. When an individual visits a particular page of that publisher's Web site via his web browser, the page is generated per the publisher's source code, while the electronic ad is generated in the ad space per the ad provider's code. The electronic advertising content is retrieved from the ad provider's ad server and fills the ad space on the Web page. The ad server maintains electronic advertising content, typically configured by the ad provider on behalf of an advertiser. Each time a visitor visits a Web page, a new set of electronic ads may be displayed because the site publisher may have business relationships with more than one ad provider or because the same ad provider may choose a different set of electronic ads to show on the Web page. Furthermore, the electronic ad code itself may specify various ads to be shown in the ad space and the ad displayed may vary per the user's particular visit to the Web page. A user may select an electronic ad, such as by clicking it, and his web browser typically is directed to present a landing page associated with the advertiser. The landing page is typically the advertiser's main Web page. For example, a user selecting an electronic ad for a dating service will be presented with the dating service's home page.

Advertising on the Internet involves an enormous market that has been growing steadily since 1995. Massive sums of money have been spent on advertising on the Internet, including tracking the performance of electronic ads and targeting advertisements to particular audiences using technologies referred to as “targeting technologies.” Yet of all electronic ads distributed on Web sites, only 0.1% are clicked. Ad providers and advertisers have perpetually grappled with the problem of low response rates. While many companies offer information and valuable offers, most electronic ads go unseen.

Meanwhile, consumers looking for products and services must sift through editorial content and corporate Web sites and e-commerce catalog sites. A product may be found, but an ad for that product (or similar product from a competing manufacturer) with a valuable offer or useful information may be missed. Unfortunately, there currently is no way for an individual to search the available inventory of electronic ads distributed via the Internet. Several difficulties prohibit searching for electronic ads. A commonly held belief is that individuals are not interested in searching for electronic ads. This outlook does not consider the possibility that an individual might desire to find an electronic ad if that ad offers a benefit of some kind. Moreover, a publishing platform to display and search electronic ads does not exist.

What is needed is a system and method that provides individuals with a convenient medium to search for electronic ads distributed via the Internet. Furthermore, what is needed is a medium through which ad entities, such as ad providers and advertisers, may reach a consumer interested in viewing electronic ads associated with their products and services.

### SUMMARY

The present invention addresses the aforementioned needs by providing a system and method for the searching of electronic ads. The present invention pertains to a registry accessible to disparate ad entities to allow for the registration of their electronic ads.

Additionally, the present invention pertains to a search module that an ad entity may employ to enable the searching of electronic ads maintained at an associated server. Furthermore, the present invention pertains to a mechanism for gathering advertising content data published via a network to enable the searching of published electronic ads.

### BRIEF DESCRIPTION OF THE DRAWINGS

In order to describe the manner in which the above-recited and other advantages and features of the invention may be obtained, a more particular description of the invention briefly described above will be rendered by reference to specific embodiments thereof that are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 illustrates a general architecture overview of an embodiment of an electronic ad searching system.

FIG. 2 illustrates an embodiment of an electronic ad searching system server.

FIG. 3A illustrates a flowchart process for registering an electronic ad at an electronic ad searching system server via received ad listing data.

FIG. 3B illustrates a flowchart process for registering an electronic ad at an electronic ad searching system server via electronic ad gathering.

FIG. 4 illustrates a flowchart process for searching electronic ads via the electronic ad searching system through use of an ad registry.

FIG. 5 illustrates a general architecture overview of an embodiment of an electronic ad searching system.

FIG. 6 illustrates a flowchart process for searching electronic ads via the electronic ad searching system through use of an ad server.

### DETAILED DESCRIPTION

Various embodiments of the invention are discussed in detail below. While specific implementations are discussed, it should be understood that this is done for illustration purposes only. A person with ordinary skill in the relevant art will recognize that other components and configurations may be used without parting from the spirit and scope of the invention.

### Electronic Ad Searching System (EASS)

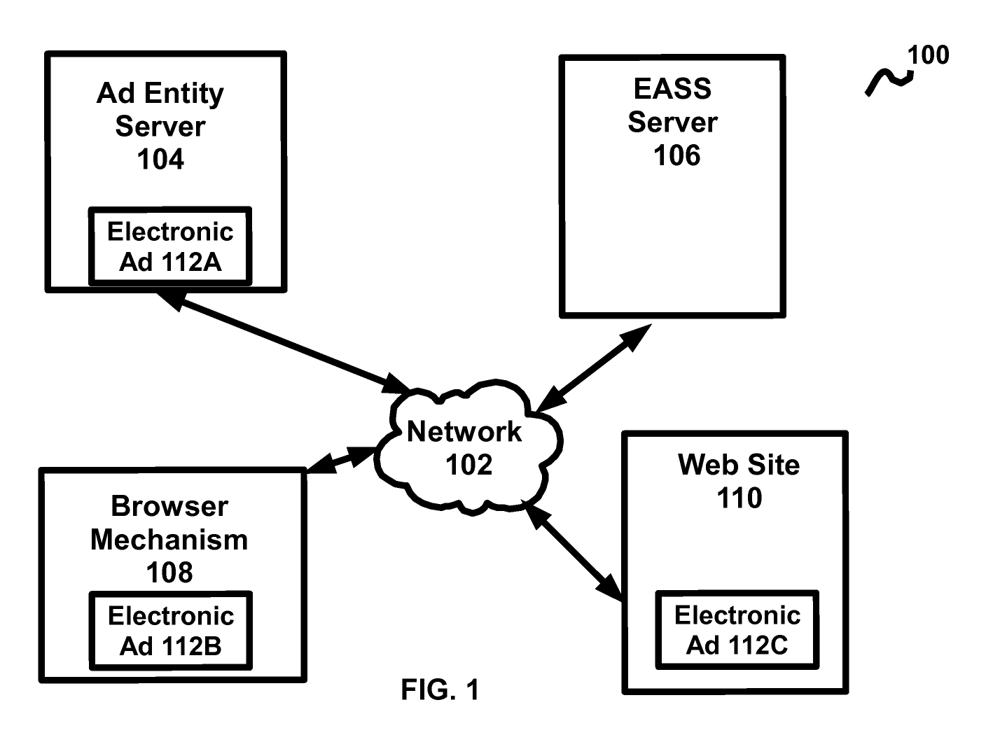

As illustrated by FIG. 1, the present invention pertains to an electronic ad searching system (EASS 100). Although only a single instance of each component is depicted, this is for illustrative purposes only and is not to be construed as limiting. EASS 100 may include an ad entity server 104 and an EASS server 106. EASS 100 may also comprise a Web site 110. An ad entity may be an organization or individual that distributes electronic ads and its ad entity server 104 may maintain its electronic advertising content. For example, an ad entity may be an ad provider (e.g., Google AdSense), an advertising agency, an individual advertiser, a newspaper (e.g., with classified ads), or the like. An ad entity may distribute electronic ads via various mediums including EASS 106 server and Web site 110 or EASS 106 server may be its sole distribution mechanism. A user may interact with EASS 100 via an accessing mechanism.

The accessing mechanism may be browser mechanism 108 and may enable the user to access data from ad entity server 104, EASS server 106, or Web site 110. For example, a user may access EASS 100 by loading a Web page on his personal computer via a web browser, such as Microsoft Internet Explorer or Mozilla Firefox, or through his mobile device via its browsing application. The components of the system may interact with one another via network 102, which may be an applicable electronic network, such as the Internet or a mobile network.

The term “electronic ad” is not to be construed as limiting and may pertain to electronic data associated with an advertisement in various forms as would be appropriate to the related system component.

For example, in relation to ad entity server 104 or Web site 110, an electronic ad (e.g., electronic ad 112A and electronic ad 112C, respectively) may pertain to a data record and/or computer code. In relation to browser mechanism 108, an electronic ad (e.g., electronic ad 112B) may pertain to a visual representation of an advertisement along with other data, such as a link.

An electronic ad may include a video, an image, textual data, or any other advertising mechanism. An electronic ad may include data indicative of a particular item for sale, such as an item offered at eBay.com, Amazon.com, a catalog item, or the like.

EASS 100 may enable an individual to search for and, in turn, view electronic ads that he may or may not have seen before. A user may have a particular electronic ad in mind when entering his query, such as, for example, “Budweiser frog commercial.” Alternatively, a user may conduct a broad search to ascertain which electronic ads are available, such as “funny beer commercial.” Although electronic ads made available via EASS server 106 may have been previously distributed via other methods (e.g., published at Web site 110), they need not have been and an ad entity may employ EASS server 106 as the initial and/or sole distribution medium for one or more its electronic ads. For example, an ad entity may employ EASS 100 as a way to distribute exclusive electronic ads. A participating ad entity may not desire to allow the searching of one or more of its electronic ads for various reasons. For example, it may deem it not cost effective to allow a consumer to view easily the offers included in its electronic ads in relation to the offers of its competitors. As such, an ad entity may designate which electronic ads maintained by its ad entity server 104 are not available for EASS use. Typically, this will entail simply not sharing data regarding those electronic ads with EAS server 106.

### Electronic Ad Registration Per Received Ad Listing Data

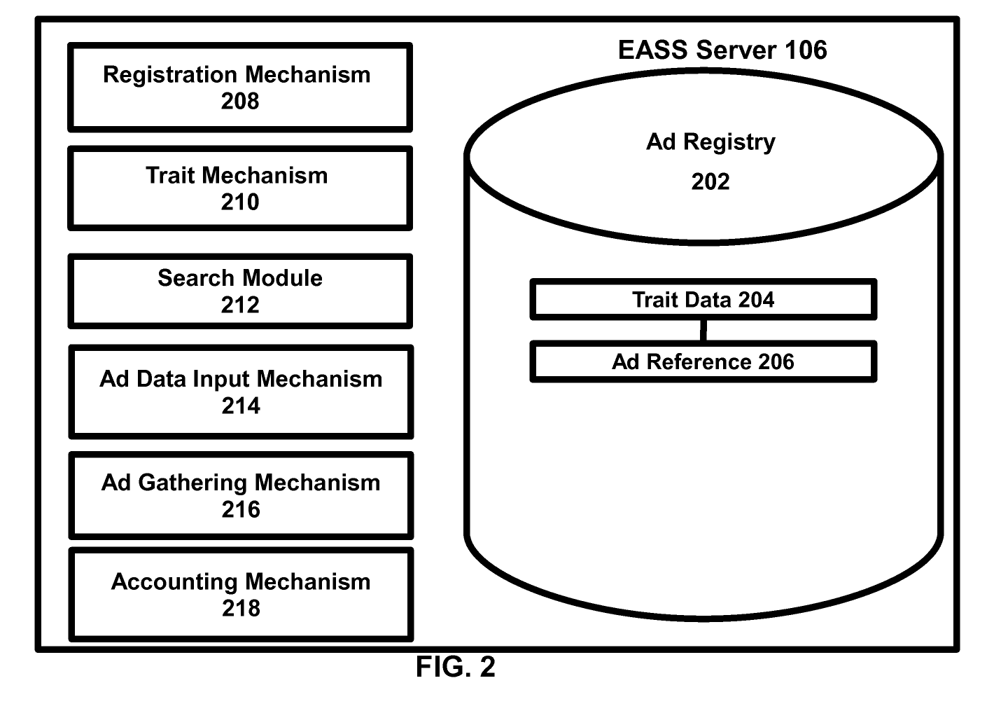

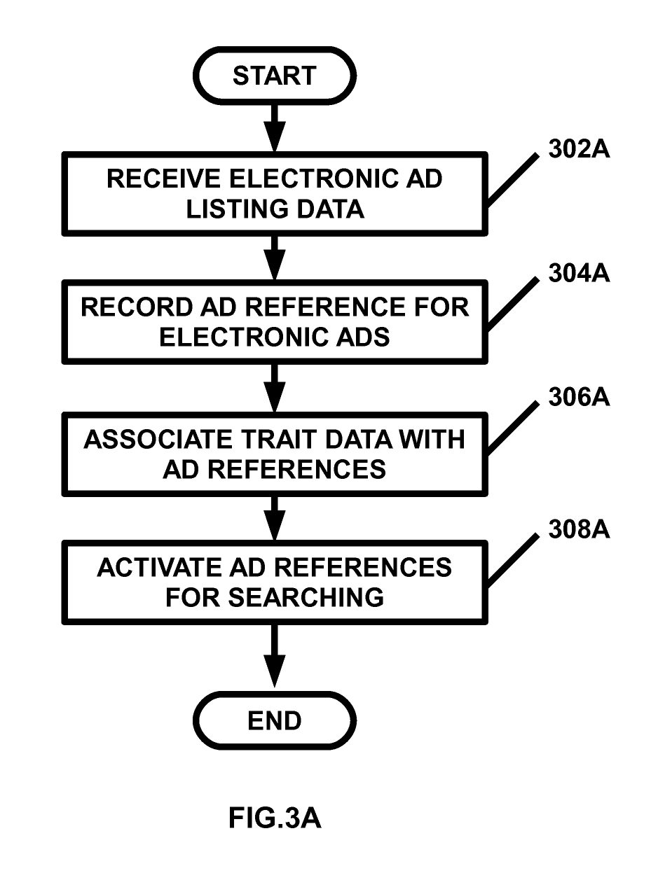

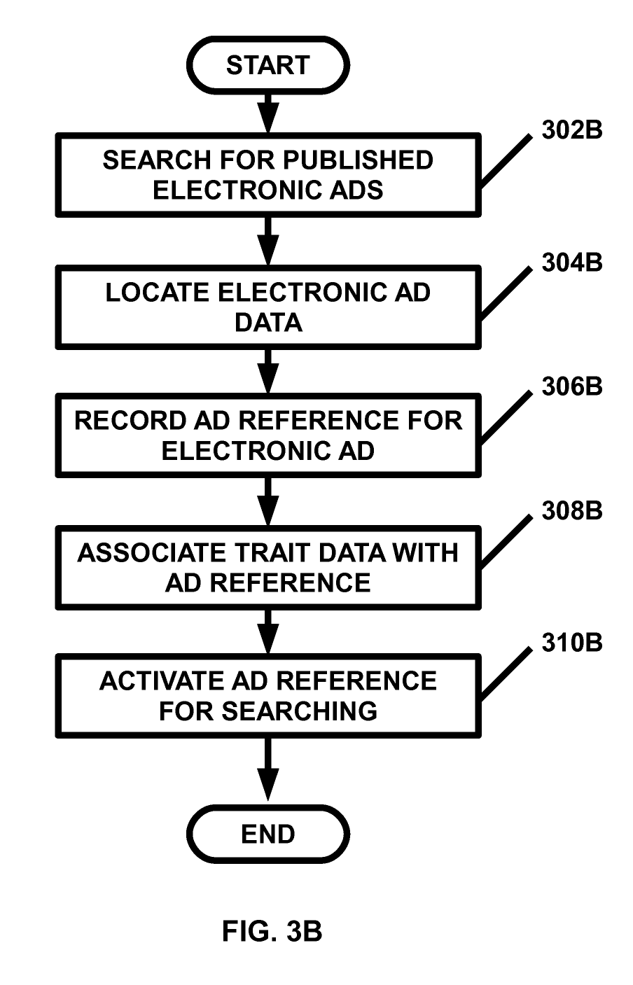

EASS server 106, an embodiment of which is depicted by FIG. 2, may be configured to include an ad registry 202 of electronic ads maintained at one or more ad entity servers 104. As depicted by FIG. 3A, EASS server 106 may receive ad listing data from an ad entity (step 302A). The ad entity may provide this data in various ways, such as by transmitting it via network 102, physically mailing the data to the EASS service provider, or the like. In one embodiment, ad listing data is received via an ad data input mechanism 214. Ad data input mechanism 214 may be configured to allow EASS server 106 to interact with ad entity server 104 or another ad entity device. Ad data input mechanism 214 may include an application programming interface (API). Ad listing data may include data regarding one or more electronic ads maintained at ad entity server 104. For example, ad listing data may include location data, such as Uniform Resource Locators (URLs). In one embodiment, ad listing data may include trait data for each electronic ad identified in the ad listing data. Registration mechanism 208 may record an ad reference 206 in ad registry 202 for each electronic ad included in the ad listing data (step 304A). An ad reference 206 may be a record including data indicative of the appropriate ad entity server 104 for the associated electronic ad. For example, an ad reference may include a URL indicating specific electronic advertising content held at ad entity server 104. Alternatively, an ad reference 206 may include an ad identifier assigned by registration mechanism 208, such as an alphanumeric identifier. EASS server 106 may share the ad identifier with ad entity server 104 so that ad entity server 104 may associate it with the appropriate electronic ad in its own records. This may assist in determining the appropriate electronic ads held at ad entity server 104 when its records are searched during a query.

Trait mechanism 210 may associate trait data 204, such as metadata, keywords, and the like, with each ad reference 206 maintained in ad registry 202 (step 306A). As aforementioned, the ad listing data may include trait data 204 associated with the included ads. For example, an ad entity may include the traits “horror,” “Stephen,” “King,” “Cujo,” and “paperback,” for an electronic ad about the Stephen King book, Cujo. Trait mechanism 210 may log these traits and associate them with the appropriate ad reference 206. Alternatively, once an ad reference 206 has been established for an electronic ad, trait mechanism 210 may be configured to access the electronic ad held at ad entity server 104 and analyze its electronic advertising content to determine appropriate traits and associate this trait data 204 with the ad reference 206 at EASS server 106. Once an ad reference 206 is associated with trait data 204, it is activated and viable for searching (step 308A).

### Electronic Ad Registration Via Electronic Ad Gathering

As illustrated by FIG. 3B, in addition to, or instead of, the aforementioned ad registration process, EASS server 106 may be configured to register electronic ads by searching network 102 for published electronic ads. For example, EASS server 106 may gather data regarding electronic ads 112C published on Web site 110 via the Internet. EASS server 106 may include ad gathering mechanism 216 which may search network 102 (such as by “crawling”) for published electronic ads (step 302B). Ad gathering mechanism 216 may be configured to analyze published electronic data in order to determine which electronic data is electronic advertising content and which is not. For example, ad gathering mechanism 216 may be configured to determine which elements of a Web page are actual site content and which are advertising content. When ad gathering mechanism 216 locates an electronic ad (step 304B), it may instruct registration mechanism 208 to record an ad reference 206 for the electronic ad in ad registry 202 (step 306B). Trait data 204 may be associated with the ad reference 206 (step 308B). Ad gathering mechanism 216 may relay published trait data 204 associated with the electronic advertising content to trait mechanism 210 which may in turn analyze it and associate it with the ad reference 206. Alternatively, trait mechanism 210 may access the electronic advertising content and analyze it to determine appropriate trait data 204 to record in association with the ad reference 206. The ad reference may then be activated and viable for searching (step 310B).

### Electronic Ad Searching at EASS Server

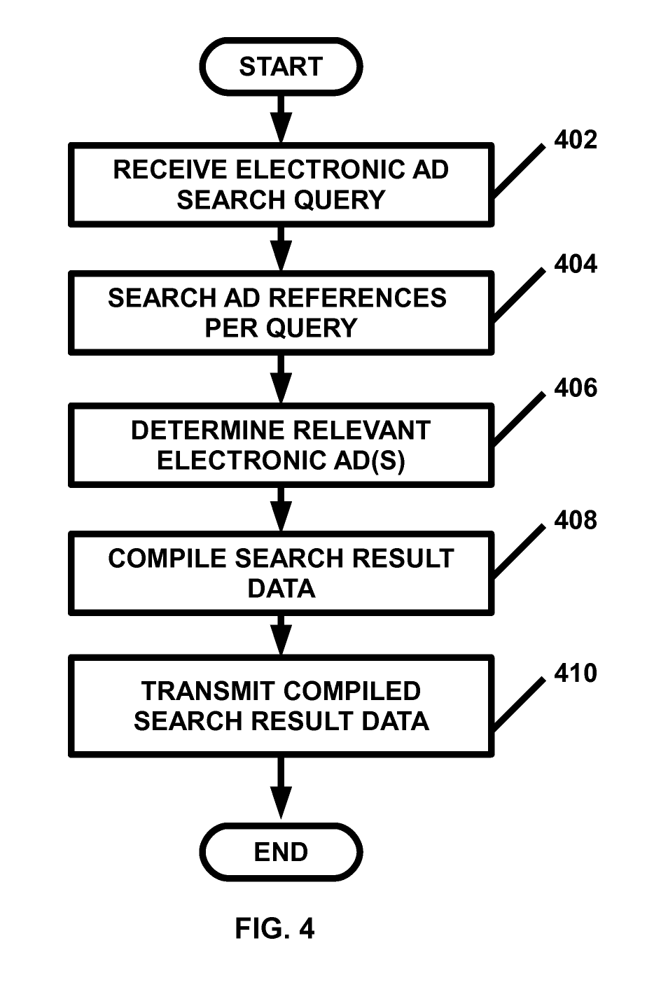

A user may employ browser mechanism 108 to search for an electronic ad via EASS server 106. As illustrated by FIG. 4, EASS server 106 may receive a search query from browser mechanism 108 (step 402). For example, a user may direct his web browser to a search site that interfaces with EASS server 106. The search site may be designed specifically for ad searching, or may be capable of various search types. The user may input a search query, such as “Super Bowl 2008,” and the ad search site may transmit this query to EASS server 106. The query is received by search module 212, which may employ the criteria included in the query to search the ad references 206 maintained in ad registry 202 (step 404) and determine if any ad references 206 pertain to electronic ads with trait data 204 relevant to the query (step 406). Once search module 212 has determined which ad references 206 are associated with electronic ads relevant to the query, it may compile the search result data (step 408) and transmit it to browser mechanism 108 for presentation (step 410).

### Electronic Ad Searching at Ad Entity Server

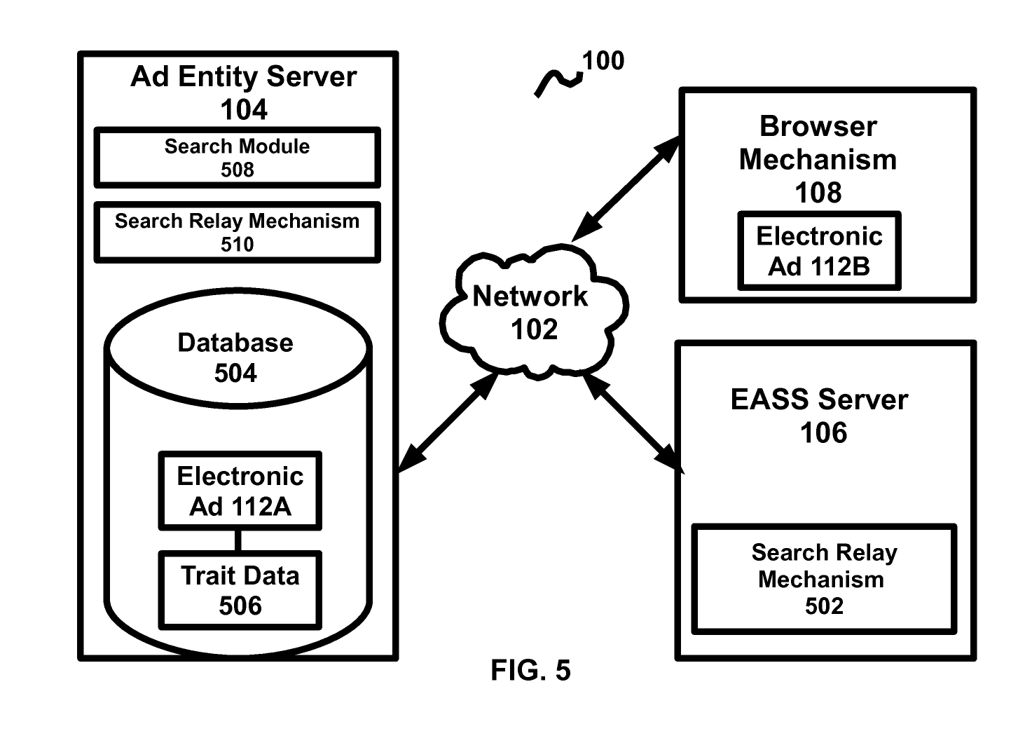

In an alternate embodiment, as illustrated by FIG. 5, EASS server 106 need not maintain an ad registry 202. When EASS server 106 receives a search query, it may employ search relay mechanism 502 to interface with one or more ad entity servers 104. Search relay mechanism 502 may enable communication between EASS server 106 and ad entity server 104 during a search. In one scenario, search relay mechanism 502 may include an API. Search relay mechanism 502 may transmit the received search query to ad entity server 104. Ad entity server 104 may maintain a database 504 which includes trait data 506 for the electronic ads 112A maintained within its own records. The trait data 506 maintained at ad entity server 104 may be generated by ad entity server 104 itself or another mechanism employed by the ad entity. Ad entity server 104 may also include its own search module 508, thereby enabling ad entity server 104 to search database 504. Additionally, ad entity server 104 may include its own search relay mechanism 510 in order to communicate with other servers maintaining electronic advertising content. Search module 508 and/or search relay mechanism 510, and/or the means to configure them, may be provided by the EASS 100 system provider when an ad entity opts to participate in EASS 100.

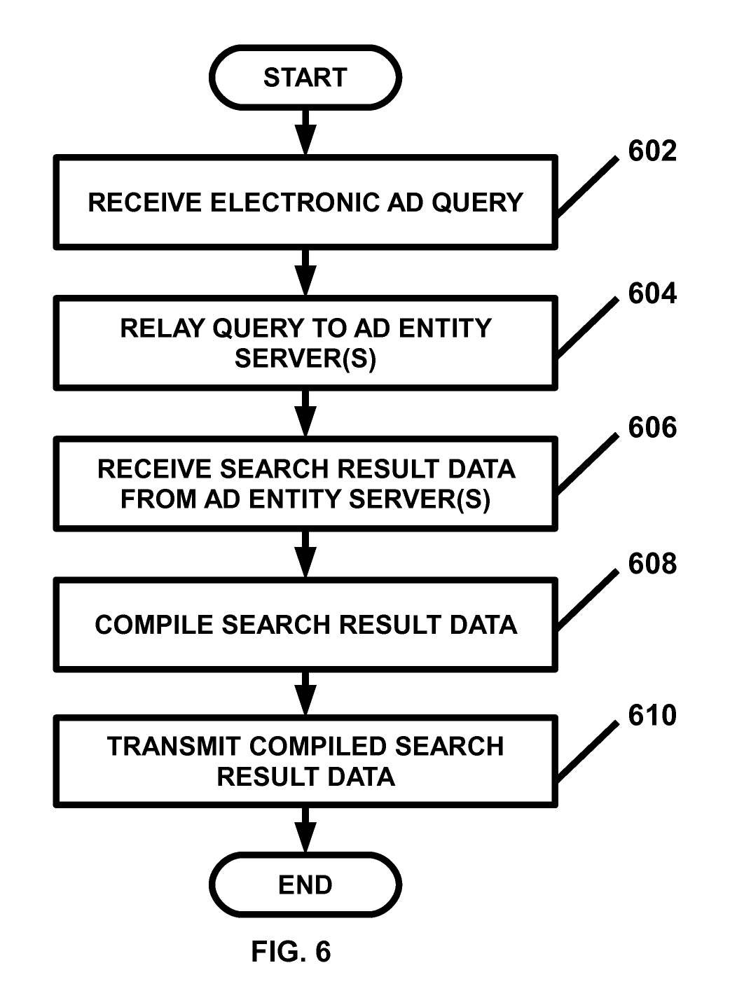

As depicted by FIG. 6, the aforementioned alternative configuration may allow for the retrieval of data from ad entity server 104 during an electronic ad search request. When EASS server 106 receives an electronic ad query from browser mechanism 108 (step 602), search relay mechanism 502 may relay the query to one or more participating ad entity servers 104 (step 604). Search module 508 may employ the query data to search database 504 for electronic ads 112A associated with trait data 506 relevant to the query. In one embodiment, an ad entity server 104 may also include its own search relay mechanism 510 and search relay mechanism 510 may relay the query data to other networked servers (not depicted), thereby enabling ad entity server 104 to serve as an intermediary in addition to, or instead of, being a direct source of search result data. EASS server 106 may then receive the search result data from each participating ad entity server 104 (step 606). If ad entity server 104 employed search relay mechanism 510, the search result data provided may include data from one or more additional servers networked to ad entity server 104. In one embodiment, ad entity server 104 may include the electronic advertising content for each electronic ad in the search result data. In another embodiment, the search result data provided may include computer code which may be employed by browser mechanism 108 to retrieve the electronic adverting content from ad entity server 104, EASS server 106, or another networked server. Once EASS server 106 has received search result data from each participating ad entity server 104, it may compile the search result data (step 608) and transmit it to browser mechanism 108 for presentation (step 610).

A straightforward approach to implementation of the present invention is to allow a user to input a keyword or phrase which is then used to generate a web page with an ad slot, wherein the ad slot fetches an ad from an ad entity, for example, Google AdSense. The query to Google AdSense in this example, will be made with the keyword entered by the user, thereby fetching an ad matching the keyword or phrase entered by the user. In this way, in order to deliver a relevant ad, as an alternative to, or in addition to algorithmic matching of ads to a predicted desire of a user, the ad server can be prompted to deliver an ad matching the explicitly entered keyword or phrase. The query sent to the ad entity can be augmented by more keywords that are automatically generated by the query module in order to improve the performance of the ad entity in providing relevant ads.

### Search Results Presentation and Interaction

The manner in which search result data may be presented upon browser mechanism 108 may vary per implementation. In one scenario, the user is presented with a compilation of ad images, such as thumbnail images, associated with the electronic ads. If the electronic ad is associated with an offer that may expire, the user may be informed of whether the offer is still valid and, if so, when it will expire. A user may select an ad image (e.g., click it with a mouse) to view the electronic ad. The electronic ads may be presented in the order in order of relevancy, for example, displaying the most relevant first. In one implementation, participating ad entities may affect the presentation order of electronic ads. For example, an ad entity may compensate the EASS service provider in order to have its ad presented advantageously. Additionally, the user may be enabled to sort his search results as he wishes, such as by expiration date, title, and the like.

Upon selecting the electronic ad, the user's browser mechanism 108 may be directed to the ad's landing page. Alternatively, upon selecting the electronic, the user's browser mechanism 108 may present the electronic ad immediately on the present screen or may present the electronic ad on a special presentation page that is associated with the EASS service.

Regardless of the search process employed, EASS server 106 may receive complete electronic advertising content from ad entity server 104 or Web site 110 when compiling the search result data and may relay this content to browser mechanism 108 for presentation. This may allow browser mechanism 108 to present an electronic ad without retrieving further data from EASS server 106, ad entity server 104, or Web site 110. Alternatively, EASS server 106 may obtain computer code from ad entity server 104 or Web site 110 and this computer code may indicate the location of the electronic ad at ad entity server 104 (or an affiliate server), Web site 110, or the like. EASS server 106 may relay this computer code in the search result data, thereby enabling browser mechanism 108 to retrieve the electronic advertising content from the appropriate location. In another embodiment, rather than providing browser mechanism 108 with actual electronic advertising content, EASS server 106 may aggregate the search result data and generate a retrieval code. The retrieval code may be transmitted to browser mechanism 108, which may employ the retrieval code to interface with the relevant ad entity servers 104 and/or Web sites 110 in order to retrieve the relevant electronic advertising content for presentation of the electronic ads included in the search results. Alternatively, EASS server 106 may serve as an intermediary. The retrieval code may include ad reference data, such as an ad identifier, and the retrieval code may instruct browser mechanism 108 to request the electronic advertising content from EASS server 106. The EASS server 106 may in turn retrieve the content from the ad entity server 104 or Web site 110 indicated by the ad reference data and relay it to browser mechanism 108 for presentation.

### Electronic Ad Tracking and Interaction

EASS 100 may enable ad entity server 104 to track the user interaction with an electronic ad presented via EASS server 106. This functionality may be enabled by accounting mechanism 218, which may be an API, to which any ad entity server 104 may connect. Electronic ads may operate via various budgeting schemes and, therefore, specific accounting processes may be necessary in order to ensure accurate accounting of an electronic ad presented via EASS 100.

The accounting process employed may be associated with the method of electronic ad presentation. If the presentation of an electronic ad included in a search result is handled in a fashion similar to an electronic ad displayed at a Web page (i.e., the electronic advertising content is retrieved from ad entity server 104 or Web site 110), ad entity server 104 may treat the viewing of the electronic ad in the same manner as an ad presented on a standard Web page. If all of the data necessary for displaying an electronic ad has been relayed through EASS server 106, browser mechanism 108 may interface solely with EASS server 106 to display the electronic ad, and accounting mechanism 218 may maintain a viewing log for presented electronic ads and relay this viewing data to ad entity server 104, instantly, periodically, or the like. If the presentation of an electronic ad requires EASS server 106 to serve as an intermediary between browser mechanism 108 and ad entity sever 104, one or more of EASS server 106 and ad entity server 104 may track the viewing of electronic ads.

Interfacing with a Personal Advertisement Storage System

In addition to interfacing with the components and entities previously described, EASS 100 may be configured to interact with a personal advertisement storage system (PASS), such as the ones described in provisional application No. 61/172,222, filed Apr. 4, 2009, entitled “Electronic Advertisement Storage, Retrieval, and Sharing,” and provisional application 61/257,837, filed Nov. 3, 2009, entitled “System and Method for Improving E-Commerce.” Both aforementioned applications are incorporated by reference herein, in their entirety, for all purposes. For example, EASS server 106 may interact with the PASS server disclosed in either of the aforementioned applications and thereby enable users to store and share electronic ads they discover via searching. In one embodiment, the EASS server 106 and the PASS server may be components of the same system and may be managed by the same service provider.

These and other aspects of the present invention will become apparent to those skilled in the art by a review of the preceding detailed description. Although a number of salient features of the present invention have been described above, the invention is capable of other embodiments and of being practiced and carried out in various ways that would be apparent to one of ordinary skill in the art after reading the disclosed invention. Therefore, the description should not be considered to be exclusive of these other embodiments. Also, it is to be understood that the phraseology and terminology employed herein are for the purposes of description and should not be regarded as limiting.

What is claimed is:

1. A method for registering electronic ads at a server to enable the searching of the electronic ads, the method comprising:
receiving, at a server, information associated with an electronic ad;
recording an ad reference for the electronic ad in an ad registry per the received electronic ad information;
determining trait data relevant to the electronic ad;
associating the trait data with the recorded ad reference;
activating the recorded ad reference, wherein the activating the recorded ad reference enables the recorded ad reference to be found in response to a search query using the trait data associated with the recorded ad reference.

2. The method of claim 1, wherein receiving, at a server, information associated with an electronic ad comprises receiving information transmitted by an ad entity.

3. The method of claim 1, wherein receiving, at a server, information associated with an electronic ad comprises receiving information gathered from a published instance of the electronic ad.

4. The method of claim 1, wherein information associated with an electronic ad includes trait data relevant to the electronic ad.

5. The method of claim 4, wherein determining trait data relevant to the electronic ad comprises analyzing the received information associated with the electronic ad.

6. The method of claim 1, wherein received electronic ad information includes location data.

7. The method of claim 6, wherein the location data indicates an ad entity server maintaining the electronic ad.

8. The method of claim 6, wherein the location data indicates a Web site at which the electronic ad is published.

9. A method for enabling the searching of electronic ads, the method comprising:
receiving, at an electronic ad searching server from a browser mechanism, a query for an electronic ad;
determining searching result data, wherein the search result data includes data indicative of one or more electronic ads relevant to the query;
compiling the search result data, wherein the compiled search result data enables the presentation of the one or more electronic ads relevant to the query; and
transmitting the search result data to the browser mechanism.

10. The method of claim 9, wherein determining search result data comprises:
searching one or more ad references maintained in an ad registry at the electronic ad searching server, wherein each ad reference is associated with trait data relevant to an electronic ad and location data indicative of the location of the electronic ad;
selecting one or more ad references relevant to the query per the associated trait data; and
retrieving the location data for each electronic ad associated with each selected ad reference.

11. The method of claim 9, wherein determining search result data comprising:
relaying the query from the electronic ad searching server to one or more ad entity servers, wherein each ad entity server is configured to search its database for electronic ads associated with trait data relevant to the query and select one or more electronic ads relevant to the query per the associated trait data; and
receiving data indicative of one or more relevant electronic ads maintained at each ad entity server.

13. A system for enabling the searching of electronic ads, the system comprising:
an electronic network;
an accessing mechanism, wherein the accessing mechanism is enabled to transmit an electronic ad search query and to display an electronic ad; and
an electronic ad searching server, wherein the electronic ad searching server further comprises:
a data receiving mechanism, wherein the data receiving mechanism is configured to receive data associated with one or more electronic ads;
a registration mechanism, wherein the registration mechanism is configured to record an ad reference in an ad registry for each electronic ad in the received electronic ad data, wherein the ad reference includes an indication of the location at which the electronic ad is maintained;
an ad registry, wherein the ad registry is configured to maintain one or more ad references and trait data associated with each ad reference;
a trait mechanism, wherein the trait mechanism determines trait data relevant to an electronic ad for which there is an ad reference in the ad registry and associates the trait data which the appropriate ad reference; and
a search module, wherein the search module is configured to receive a query from the accessing mechanism, search for relevant electronic ads by determining which ad references maintained in the ad registry are associated with trait data relevant to the received query, interact with the location indicated by an ad reference in order to compile electronic ad search result data per the received query, and transmit the compiled search result data to the accessing mechanism.

14. The system of claim 13, wherein the data receiving mechanism comprises an ad data input mechanism configured to receive electronic ad data transmitted by one or more ad entities.

15. The system of claim 13, wherein the data receiving mechanism comprises an ad gathering mechanism configured to search the electronic network for published electronic ads and to retrieve data associated with the published electronic ads.

16. The system of claim 13, wherein the trait mechanism is configured to determine trait data by analyzing the received electronic ad data.

17. The system of claim 13, wherein the train mechanism is configured to determine trait data by accessing the electronic ad at the location where it is maintained.

18. The system of claim 13, further comprising an accounting mechanism, wherein the accounting mechanism enables the tracking of user interaction with an electronic ad provided to the accessing mechanism in the compiled search results data.
